(19) United States
(12) Patent Application Publication
(10) Pub. No.: US 2015/0218018 A1
(43) Pub. Date: Aug. 6, 2015

(54) WASTEWATER TREATMENT MODULE USING MEMBRANE DISTILLATION AND WASTEWATER TREATMENT APPARATUS INCLUDING THE SAME

(71) Applicant: KOREA INSTITUTE OF SCIENCE AND TECHNOLOGY, Seoul (KR)

(72) Inventors: Seockheon Lee, Seoul (KR); Seong Pil Jeong, Seoul (KR)

(73) Assignee: KOREA INSTITUTE OF SCIENCE AND TECHNOLOGY, Seoul (KR)

(21) Appl. No.: 14/178,784

(22) Filed: Feb. 12, 2014

(30) Foreign Application Priority Data
Feb. 4, 2014 (KR) 10-2014-0012756

(51) Int. Cl. C02F 1/44; B01D 69/10

(52) U.S. Cl. CPC C02F 1/447; B01D 69/10; B01D 2325/38; C02F 2103/08

(57) ABSTRACT

An aspect of the invention relates a wastewater treatment module using a membrane distillation. The wastewater treatment module includes: an inflow-water side including a space for receiving feed water; a treated-water side including a space for receiving treated water, wherein the treated-water side coupled to the inflow-water side; and a separation membrane interposed between the inflow-water side and the treated-water side. The separation membrane has a bent shape.

### CROSS-REFERENCE TO RELATED APPLICATION

This application claims priority to and the benefit of Korean Patent Application No. 10-2014-0012756 filed in the Korean Intellectual Property Office on Feb. 4, 2014, the entire contents of which are incorporated herein by reference.

### BACKGROUND OF THE INVENTION

(a) Field of the Invention

The invention relates to a wastewater treatment module using a membrane distillation and a wastewater treatment apparatus including the same.

(b) Description of the Related Art

In a membrane distillation method, phase transformation is generated at a surface of a separation membrane consisting of a hydrophobic polymer, vapor penetrates through fine pores at the surface of the separation membrane, and the vapor is cooled and separated. The membrane distillation method may be used for a desalinization process for separation and eliminating a non-volatile material or a material having low volatility, or for separating an organic material having high volatility from an aqueous solution.

Since a concept of a membrane distillation method was suggested in 1960, the membrane distillation method has been generally studied at the United States, Europe, Japan, and Australia. Recently, an attempt for replacing an evaporation method or a reverse osmosis method with the membrane distillation method is active.

The evaporation method or the reverse osmosis method currently used for the desalinization process or a process to manufacture pure water needs a lot of energy. Specifically, in the reverse osmosis method, several preconditioning processes are performed before the operation, due to the pollution and the fouling. Thus, management of the operation is difficult, and a lot of an electric energy is used and a running cost is high because of the reverse osmosis method is operated at a high pressure.

Meanwhile, the membrane distillation method uses a porous membrane and a separation is achieved by a vapor (partial) pressure difference. Also, the membrane distillation method is performed at a low pressure, compared with an ultrafiltration method and the reverse osmosis method. In addition, in the membrane distillation method, entrainment, which may be induced in the conventional evaporation method, is not generated during the separation and elimination of a non-volatile material like a salt. Further, a filter or a separation membrane operated at the high pressure is not necessary.

Also, the membrane distillation method uses a separation membrane consisting of a hydrophobic polymer. Since surface tension of solvents and solutes (hydrophilic materials) is larger than that of a surface of the separation membrane, a material of a liquid state does not penetrate through membrane pores, and is repulsed from the surface of the separation membrane. Thus, the material that is necessary to be separated is phase-transformed to a vapor state at an entrance of the membrane pores of the separation membrane, is diffused to and penetrates through the membrane pores, and finally cooled and separated at a treated-water side.

The membrane distillation method is performed at a wastewater treatment module including an inflow-water side and the treated-water side. Inflow water flows into the inflow-water side, a material of the inflow water penetrates through the separation membrane, and the separated material is cooled and separated at the treated-water side.

By the advantages of the membrane distillation method, low-cost utility can be applied and durability of a separation apparatus can be high in a desalination process using the membrane distillation method. Thus, the membrane distillation method is risen as the most competitive method to manufacture drinking water all over the world.

However, in the membrane distillation method, the vapor pressure difference is induced between the inflow-water side and the treated-water side, and thus, the separated material having the vapor state penetrates through the separation membrane only. Thus, besides the above advantages, an output of the treated water in the membrane distillation method is low, compared with different wastewater treatment methods.

Accordingly, by maximizing the output of the treated water at a membrane distillation apparatus of the same size, technology development to increase wastewater-treatment efficiency is necessary.

The above information disclosed in this Background section is only for enhancement of understanding of the background of the invention and therefore it may contain information that does not form the prior art that is already known in this country to a person of ordinary skill in the art.

### SUMMARY OF THE INVENTION

The invention is directed to a wastewater treatment apparatus using a membrane distillation being able to increase wastewater-treatment efficiency by increasing an amount of vapor moving from inflow water, which flows into an inflow-water side, to a treated-water side through a separation membrane due to vapor pressure difference.

An aspect of the invention relates a wastewater treatment module using a membrane distillation. The wastewater treatment module includes: an inflow-water side including a space for receiving feed water; a treated-water side including a space for receiving treated water, wherein the treated-water side coupled to the inflow-water side; and a separation membrane interposed between the inflow-water side and the treated-water side. The separation membrane has a bent shape.

The separation membrane may have the bent shape by a support frame.

The support frame may include at least one opening.

Each of at least a part of coupled surfaces of the inflow-water side and at least a part of the treated-water side may have a bent shape. The coupled surface of the inflow-water side and the coupled surface of the treated-water side may be engaged with each other. The separation membrane may have the bent shape according to the bent shapes of the coupled surfaces of the inflow-water side and the treated-water side facing each other between the coupled surfaces of the inflow-water side and the treated-water side.

The bent shape of the separation membrane or the coupled surface may have at least one of a serrated shape, a polygonal shape, at least a part of a circular shape, and a rounded shape.

The separation membrane may include a hydrophobic polymer. Various hydrophobic polymers may be used for the separation membrane. The hydrophobic polymer includes at least one selected from a group consisting of polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA).

The separation membrane may include a surface pore having a size of about 0.1 um to about 1 um.

The separation membrane may have a thickness of about 30 um to about 60 um.

A wastewater treatment apparatus using membrane distillation according to another aspect of the invention includes the wastewater treatment module.

### BRIEF DESCRIPTION OF THE DRAWINGS

FIG. 1 illustrates a structure of a wastewater treatment apparatus using a membrane distillation including a wastewater treatment module using the membrane distillation according to an embodiment of invention.

FIG. 2 illustrates a separation membrane having a bent shape by a support frame, according to an embodiment of the invention.

FIG. 3 is an exploded perspective view of a wastewater treatment module using a membrane distillation, according to another embodiment of the invention.

### DETAILED DESCRIPTION OF THE EMBODIMENTS

Hereinafter, an embodiment of the invention will be described in more detail.

An aspect of the invention relates to a wastewater treatment module using a membrane distillation. More particularly, the wastewater treatment module using the membrane distillation comprises an inflow-water side including a space for receiving inflow water; a treated-water side including a space for receiving treated water, wherein the treated-water side coupled to the inflow-water side; and a separation membrane interposed between the inflow-water side and the treated-water side. The separation membrane has a bent shape.

In an example of the invention, the separation membrane has a bent shape by the support frame.

The invention is not limited to a material of the support frame. For the support frame, a material having low heat transfer coefficient, such as plastic, a crystalline material, and so on, may be used. Also, for the support frame, a material having high heat transfer coefficient, such as a metal (iron, aluminum, copper, and so on) and carbon nano tube, may be used. In addition, in some cases, a compound or a mixture of materials having different heat transfer coefficients may be used for the support frame.

The support frame has a bent shape. The bent shape of the support frame is not limited. For example, the bent shape of the support frame has a sharp shape, a rounded shape, and so on. In the embodiment, in order to easily form the separation membrane having the bent shape, the support frame has a plurality of bent portions that are repeated several times. In this case, the plurality of bent portions may have uniform sizes (for example, widths), uniform shapes, and/or be symmetrical. For example, the support frame may have a shape of folding screen.

Also, the support frame includes at least one opening, and the opening has a polygonal shape, a circular shape, and so on. The shape of the opening is not limited thereto.

As methods for fixing the separation membrane to the support frame, a method for attaching the separation membrane to the support frame by using an adhesive agent, a method for fitting the separation membrane to correspond to the opening of the support frame, and a method for inserting the separation membrane to a groove formed at the support frame for the separation membrane. However, the method for fixing the separation membrane to the support frame is not limited thereto. Thus, various methods being able to prevent the separation membrane having the bent shape by the support frame from being separated from the support frame in the wastewater treatment module and to prevent water leak may be used.

In the wastewater treatment module using the membrane distillation according to another aspect of the invention, at least parts of coupled surfaces of the inflow-water side and the treated-water side may have bent shapes. The coupled surface of the inflow-water side and the coupled surface of the treated-water side may be engaged with each other. The separation membrane may have a bent shape according to (or being consistent with) the bent shapes of the coupled surfaces of the inflow-water side and the treated-water side facing each other between the coupled surfaces of the inflow-water side and the treated-water side.

The bent shape of the separation membrane or the coupled surface is not limited to predetermined shape. For example, the bent shape of the separation membrane or the coupled surface may have at least one of a serrated shape, a polygonal shape, at least a part of a circular shape, and a rounded shape.

As methods for fixing the separation membrane to the wastewater treatment module, various methods being able to treat inflow water without water leak of the inflow water and the treated water by engaging the separation membrane with the coupled surface of the inflow-water side and the coupled surface of the treated-water side may be used. For example, at least parts of the inflow-water side and the treated-water side are detachable or separable. Then, the separation membrane is fixed to the wastewater treatment module by separating the at least parts of the inflow-water side and the treated-water side from each other, interposing the separation membrane between the inflow-water side and the treated-water side, and coupling the inflow-water side and the treated-water side while interposing the separation membrane. In another example, the coupled surfaces between the inflow-water side and the treated-water side have a groove or a gap. Then, the separation membrane is fixed to the wastewater treatment module by inserting the separation membrane to the groove or the gap.

In the embodiment, the separation membrane may include (or be consists of) a hydrophobic polymer.

Various hydrophobic polymers may be used for the separation membrane. For example, at least one selected from a group consisting of polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA) may be used for the separation membrane.

A size (or sizes) of a surface pore (or surface pores) of the separation membrane is not limited. For example, the size of the surface pore may be about 0.1 um to about 1 um. In this range, excessive decrease of membrane permeability coefficient may be prevented, and water penetration through the separation membrane may be maximally suppressed. Also, a thickness of the separation membrane is not limited. For example, the thickness of the separation membrane may be freely selected in a range from about 20 um to about 300 um according to a purpose of use and an operating condition. The thickness of the separation membrane may be about 30 um to about 60 um in order to satisfy high membrane permeability coefficient and high membrane durability at the same time.

As in the above, the wastewater treatment module includes the separation membrane having the bent shape, and thus, a surface area of the separation membrane can increase. The separation membrane may be bent by the support frame, and thus, the separation membrane may be maintained to have the bent shape. In another embodiment, the bent shape of the separation membrane may be formed by the bent shaped part of the wastewater treatment module where the separation membrane is engaged when the separation membrane is coupled to the wastewater treatment module. Thus, the bent shape of the separation membrane is maintained when it is coupled to the wastewater treatment module.

Another aspect of the invention relates to a wastewater treatment apparatus using a membrane distillation. The wastewater treatment apparatus using the membrane distillation include the above wastewater treatment module using the membrane distillation.

In the embodiment, the wastewater treatment apparatus includes an inflow-water side that inflow water flows into and a treated-water side where treated water is discharged.

In the wastewater treatment module, the inflow-water side is an area where the inflow water flowing from the outside passes. During the inflow water flowing from the outside passes through the inflow-water side, vapor (or a steam) contained in the inflow water moves to the treated-water side through a separation membrane due to a vapor pressure difference between the inflow-water side and the treated-water side.

In the embodiment, the inflow water may be various types of waters that the pure water should be separated. For example, the inflow water may be waste water, seawater, and so on. In order to generate the vapor pressure difference between the inflow-water side and the treated-water side, the inflow water at the inflow-water side of the wastewater treatment module has relatively high temperature, compared with the treated water at the treated-water side. The temperature difference between the inflow-water side and the treated-water side is not limited. The temperature difference may be about 600° C. or less, considering energy efficiency and yield of the pure water.

On the other hand, in the embodiment, in order to increase an amount of the vapor penetrating through the separation membrane, it is preferable that the temperature of the inflow-water side is high. This is because the vapor pressure increases as the temperature of the inflow water at the inflow-water side increases. Then, the vapor pressure difference between the inflow-water side and the treated-water side that is a driving force of vapor penetration through the separation membrane increases.

In the wastewater treatment apparatus according to the embodiment, the supply of the inflow water (or feed water) may be repeatedly stopped for a predetermined time to increase the amount of the purified water. After obtaining sufficient amount of the purified water by stopping the supply of the inflow-water side, the remained inflow water is discharged to the outside of the wastewater treatment module, and new inflow water is supplied to the inflow-water side inside wastewater treatment apparatus. This process may be performed repeatedly.

Also, it is possible that the inflow water continuously may flow into the inflow-water side and the concentrated remained inflow water (concentrated water) may be discharged with a constant flow rate. In the case, when the operation time is over the predetermined time or the concentrated water increases over the predetermined concentration, the concentrated water may be discharged.

In the wastewater treatment apparatus according to the embodiment, the flow of the inflow-water side is not continuously maintained, but the inflow water of the inflow-water side flows with predetermined time intervals. Accordingly, energy for driving a pump for supplying the inflow water can be reduced, compared with the conventional wastewater treatment apparatus using the membrane distillation.

In some cases, a space for receiving the inflow water of the inflow-water side may be smaller than a space for receiving the treated water of the treated-water side. Then, the inflow water flowing into the wastewater treatment module can be rapidly heated. In the embodiment, the volume ratio of the space for receiving the inflow water of the inflow-water side: the space for receiving the treated water of the treated-water side is not limited. For example, the volume ratio of the space for receiving the inflow water of the inflow-water side: the space for receiving the treated water of the treated-water side may be about 1:1.01 to about 1:100. When the volume ratio is below about 1:1.01, the effect that the heating time of the inflow water at the inflow-water side decreases may be slight or insignificant, compared with the case that the volume ratio is 1:1. When the volume ratio is above about 1:100, the space for receiving the inflow water of the inflow-water side may be excessively small, and thus, the required amount of the pure water may be not achieved.

In the wastewater treatment apparatus according to the embodiment, the treated-water side is an area where the vapor passing through the separation membrane is condensed and separated. The treated water, which is the pure water separated from the inflow water through the separation membrane, is collected and passes at the treated-water side. In the embodiment, the treated water at the treated-water side of the wastewater treatment module has relatively low temperature, compared with the inflow water.

A structure of the wastewater treatment apparatus according to the invention is not limited. For example, the wastewater treatment has a submerged structure, a pressurized structure, and so on. Also, a type of the wastewater treatment apparatus according to the invention is not limited. For example, the wastewater treatment apparatus has a direct contact membrane distillation (DCMD) type, an air gap membrane distillation (AGMD) type, a vacuum membrane distillation (VMD) type, a sweep gas membrane distillation (SGMD), and so on.

An embodiment of the invention will be described with reference to an accompanying drawing. However, the following embodiment is an example for describing the invention, and the invention is not limited thereto.

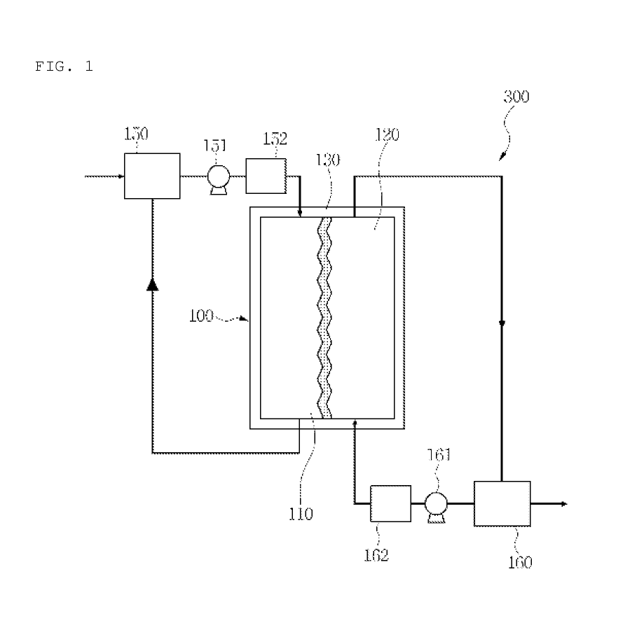

FIG. 1 illustrates a structure of a wastewater treatment apparatus using a membrane distillation including a wastewater treatment module using a membrane distillation according to an embodiment of invention. As shown in FIG. 1, a wastewater treatment module 100 using a membrane distillation according to an embodiment of the invention includes an inflow-water side 110, a treated-water side 120, and a separation membrane 130.

The inflow-water side 110 is an area of the wastewater treatment module 100 where inflow water flowing from the outside stays. When the inflow water flowing from the outside stays at the inflow-water side 110, vapor (or a steam) contained in the inflow water moves the treated-water side 120 through the separation membrane 130 due to a vapor pressure difference between the inflow-water side 110 and the treated-water side 120.

The inflow water flowing into and staying at the inflow-water side 110 at an adjacent space of the separation membrane 130 is heated before flowing into the inflow-water side 110 by heat energy supplied from a heating apparatus 152. Thereby, pure water included in the inflow water inside the inflow-water side 110 is evaporated to form the vapor, and the vapor pressure of the inflow-water side 110 increases.

An operation process of the wastewater treatment apparatus using the membrane distillation will be described in detail with reference to FIG. 1.

First, the inflow water stored at a inflow-water storage tank 150 is flows into the inflow-water side 110 of the wastewater treatment module 100 according to the embodiment through an inflow-water circulation pump 151. In the case that the inflow-water circulation pump 151 is applied as shown in FIG. 1, if the inflow-water side 110 is entirely filled with the inflow water, the inflow water may be prevented from inflowing or may be circulated continuously. Next, the inflow water is heated during passing the heating apparatus 152 by supplied heat energy, before flowing into the inflow-water side 110. Thereby, the pure water included in the inflow water inside the inflow-water side 110 is evaporated to form the vapor, and the vapor pressure of the inflow-water side 110 increases. On the other hand, the treated-water side 120 of the wastewater treatment module 100 is an area where the treated water passes and is continuously circulated. The treated water flows from a treated-water storage tank 160 to the wastewater treatment module 100 through the treated-water circulation pump 161. During the process, the treated water is cooled by a cooling apparatus 162 and flows into the treated-water side 120 of the wastewater treatment module 100. The treated water is continuously circulated, and apart of the treated water stored at the treated-water storage tank 160 is discharged as the pure water. The vapor pressure difference is generated by the temperature between the inflow-water side 110 and the treated-water side 120. By the vapor pressure difference between the inflow-water side 110 and the treated-water side 120, the vapor of the pure water included in inflow water of the inflow-water side 110 moves to the treated-water side 120 through the separation membrane 130. And then, the vapor at the treated-water side 120 is cooled by the low temperature of the treated-water side 120, and thus, transforms to the pure water. Since the separation membrane 130 is hydrophobic, residues of a liquid state besides the vapored pure water of the inflow-water side 110 cannot pass through the separation membrane 130.

On the other hand, when sufficient purification of the inflow water staying at the inflow-water side 110 is performed, the remained inflow water of the inflow-water side 110 is discharged to the outside of the wastewater treatment module 100, and new inflow water is supplied to the inflow-water side 100 from the inflow-water storage tank 150 by operating the inflow-water circulation pump 151. This process is repeated several times. When the module is continuously operated, concentration of the inflow water inside the inflow-water storage tank 150 can be controlled by supplying new inflow water into the inflow-water storage tank 150. If the concentration of the inflow water inside the inflow-water storage tank 150 sufficiently increases, concentrate of the inflow water may be eliminated from the inflow-water storage tank 150 and new inflow water may be supplied.

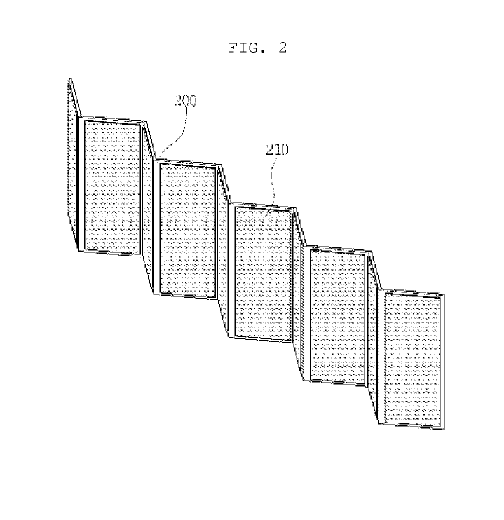

FIG. 2 illustrates a separation membrane having a bent shape by a support frame, according to an embodiment of the invention. Referring to FIG. 2, the support frame 200 has a shape of a folding screen that includes a plurality of bent shapes repeatedly positioned and includes a plurality of quadrangle openings. Each of the bent shape may have a sharp end. Also, the separation membrane 210 having a quadrangle shape is formed at each of the plurality of quadrangle openings.

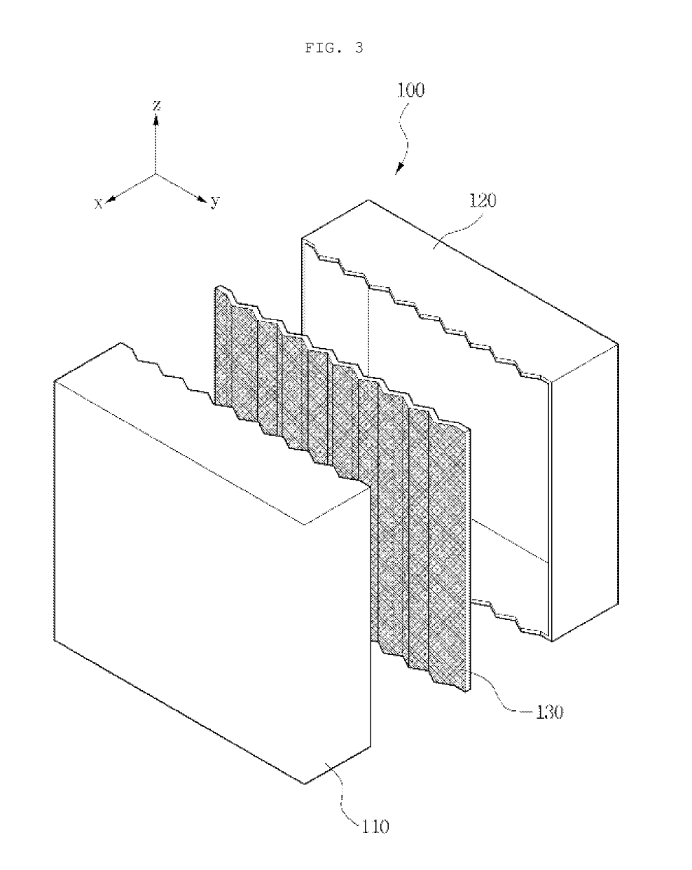

FIG. 3 is an exploded perspective view of a wastewater treatment module using a membrane distillation, according to another embodiment of the invention. Referring to FIG. 3, in the wastewater treatment module, each of coupled surfaces of the inflow-water side 110 and the treated-water side 120 facing each other has a bent shape of a serrated shape. The bent structure of the coupled surface of the inflow-water side 110 corresponds to and is engaged with the bent structure of the coupled surface of the treated-water side 120. The separation membrane 130 before fixing the wastewater treatment module 100 has a planar shape. When the separation membrane 130 is mounted on the wastewater treatment module 100, the separation membrane 130 has the bent shape corresponding to the bent shapes formed at the coupled surfaces of the inflow-water side 110 and the treated-water side 120 between the inflow-water side 110 and the treated-water side 120.

According to the embodiment, the separation membrane at the wastewater treatment apparatus using the membrane distillation has the bent shape. An area of the separation membrane where the separated material having a vapor state passes from the inflow-water side to the treated-water side is larger than that of the conventional planar separation membrane. Accordingly, the yield of the wastewater treatment apparatus using the membrane distillation can be high when the wastewater treatment apparatus according to the invention has the same scale or the same size as the conventional wastewater treatment apparatus.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wastewater treatment module using a membrane distillation, comprising:
an inflow-water side including a space for receiving feed water;
a treated-water side including a space for receiving treated water, wherein the treated-water side coupled to the inflow-water side; and
a separation membrane interposed between the inflow-water side and the treated-water side,
wherein the separation membrane has a bent shape.

2. The wastewater treatment module according to claim 1, wherein the separation membrane has the bent shape by a support frame.

3. The wastewater treatment module according to claim 2, wherein the support frame includes at least one opening.

4. The wastewater treatment module according to claim 1, wherein each of at least a part of coupled surfaces of the inflow-water side and at least apart of the treated-water side has a bent shape,
the coupled surface of the inflow-water side and the coupled surface of the treated-water side are engaged with each other, and
the separation membrane has the bent shape according to the bent shapes of the coupled surfaces of the inflow-water side and the treated-water side facing each other between the coupled surfaces of the inflow-water side and the treated-water side.

5. The wastewater treatment module according to claim 4, wherein the bent shape of the separation membrane or the coupled surface has at least one of a serrated shape, a polygonal shape, at least a part of a circular shape, and a rounded shape.

6. The wastewater treatment module according to claim 1, wherein the separation membrane includes a hydrophobic polymer.

7. The wastewater treatment module according to claim 6, wherein the hydrophobic polymer includes at least one selected from a group consisting of polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA).

8. The wastewater treatment module according to claim 1, wherein the separation membrane includes a surface pore having a size of about 0.1 um to about 1 um.

9. The wastewater treatment module according to claim 1, wherein the separation membrane has a thickness of about 30 um to about 60 um.

10. A wastewater treatment apparatus using membrane distillation comprising the wastewater treatment module according to claim 1.
